(19) United States
(12) Patent Application Publication
(10) Pub. No.: US 2005/0012062 A1
(43) Pub. Date: Jan. 20, 2005

(54) Solenoid valve

(76) Inventor: Akira Hayashi, Nissin (JP)

Correspondence Address: BURNS DOANE SWECKER & MATHIS L L P, POST OFFICE BOX 1404, ALEXANDRIA, VA, 22313-1404, US

(21) Appl. No.: 10/892,144

(22) Filed: Jul. 16, 2004

(30) Foreign Application Priority Data
Jul. 17, 2003 (JP) 2003-276197

(51) Int. Cl. F16K 31/02

(52) U.S. Cl. 251/129.15

(57) ABSTRACT

A solenoid valve includes a tubular yoke, a tubular bobbin inserted in the yoke, and a current-excitable coil wound around the bobbin. A resin fills the gap between the yoke and the coil. A core is inserted in the bobbin so as to be movable in an axial direction of the bobbin. The core carries a valve shaft having a valve body. By selectively activating the coil, the core is moved together with the valve shaft, thereby bringing the valve body into contact with and out of contact with a valve seat provided opposite the valve body. The yoke has its radially inner and/or outer surfaces roughened to increase contact surface area between the yoke and the resin, thereby speeding up conduction and thus dissipation of heat produced from the coil.

### BACKGROUND OF THE INVENTION

This invention relates to a solenoid valve used e.g. in an actuator for controlling vehicle brake hydraulic pressure.

As shown in FIG. 5, a typical actuator for controlling vehicle hydraulic brake pressure includes a hydraulic pressure control unit 1, a motor unit 2 including a motor M and mounted to one side of the control unit 1, and an electronic control unit (ECU) 3 mounted to the opposite side of the control unit 1.

The hydraulic pressure control unit 1 shown in FIG. 5 is disclosed in Japanese patent publication 2001-260846 and includes a housing 10, typically made of an aluminum alloy, in which are mounted a reservoir 12, a pump 13 driven by the motor M, a pressure increase control valve 30 and a pressure reduction control valve 20. The housing 10 has a master cylinder port 14 and a wheel cylinder port 15. A passage 16 extends from the master cylinder port 14 to the wheel cylinder port 15 through the pressure increase control valve 30. Another passage 17 extends from the wheel cylinder port 15 to the reservoir 12 through the pressure reduction control valve 20. The control valves 20 and 30 and the motor M are controlled by the electronic control unit 3.

The control valves 20 and 30 are solenoid valves. As the control valve, the one similar to the valve disclosed in Japanese patent publication 4-287840 is typically used. This valve includes a tubular yoke, a tubular bobbin inserted in the yoke, a current-excitable coil wound around the bobbin, and a core (plunger) carrying a valve shaft and axially slidably supported in the bobbin through a guide. By selectively exciting the coil, the core is adapted to be moved axially to bring a valve body at the tip of the valve shaft into contact or out of contact with a valve seat.

When the coil is excited, it produces heat because it has electrical resistance. It thus heats up gradually as it is excited continuously or discontinuously. As the coil heats up, the electrical resistance of the coil increases and thus the heat buildup accelerates. The coil is usually resistant to the heat of only up to 200° C. Thus, in order to prevent overheating of the coil, an epoxy resin, which is known to have a higher heat dissipation coefficient than air, is charged into the gap between the coil and the yoke to efficiently conduct heat produced from the coil to the yoke, which is made of a material having a high heat dissipation coefficient, through the epoxy resin.

However, in spite of such efforts to prevent overheating of these solenoid valves, the possibility of overheating of these valves is increasing. This is because modern motor vehicles are equipped with a variety of high-tech devices, including an anti-lock brake system (ABS), and a vehicle stability control (VSC) system, so that solenoid valves, such as the control valves of the above-described type, tend to be activated for a longer period of time. If the heat produced from the coil when the coil is heated for a prolonged period of time is not dissipated to the yoke through the resin at a sufficiently high rate, the coil may heat up to a temperature higher than it can withstand (e.g. over 200° C.).

One way to slow down heat build-up is to increase the number of turns of the coil. But this increases the radial thickness of the coil, which in turn increases the size of the control valve, which will in turn results in an increased size of the entire hydraulic unit housing and thus the entire actuator.

An object of the invention is to provide a solenoid valve of the above-described type that includes means for improving dissipation of heat produced from the coil.

### SUMMARY OF THE INVENTION

To accomplish this object, the present invention proposes to roughen the radially inner and/or outer surfaces of the yoke, thereby increasing the surface area through which heat is dissipated.

By roughening the radially inner surface of the yoke, the resin filling the gap between the yoke and the coil infiltrates into every recess in the roughened inner surface of the yoke. This dramatically increases the contact area between the yoke and the resin, which in turn greatly speeds up the conduction of heat produced from the coil to the yoke through the resin. The yoke is preferably in contact with a housing of e.g. a hydraulic pressure control unit, which is preferably formed of e.g. an aluminum alloy, so that the heat conducted to the yoke is quickly conducted to the housing and dissipates.

The radially inner and/or outer surface of the yoke is roughened by knurling, by forming grooves by cutting or using laser beams, or by any other means. Such a rough surface or surfaces are shaped in a pattern selected from well-known patterns including a net pattern, satin pattern and a diamond pattern in view of heat dissipation.

Specifically, there is provided a solenoid valve comprising a tubular yoke, a tubular bobbin inserted in the yoke, a current-excitable coil wound around the bobbin, a resin filling a gap between the yoke and the coil, a core inserted in the bobbin so as to be movable in an axial direction of the bobbin, and a valve shaft having a valve body and joined to the core so as to be axially movable together with the core, thereby bringing the valve body into contact with and out of contact with a valve seat provided opposite the valve body, the yoke having its radially inner and/or outer surface roughened.

From another aspect of the invention, there is provided an actuator for controlling hydraulic pressure comprising a hydraulic pressure control unit including a pressure increase control valve, a pressure reduction control valve and a pump, a motor unit including a motor for driving the pump, and an electronic control unit for controlling the pressure increase control valve, the pressure reduction control valve and the motor, wherein at least one of the pressure increase control valve and the pressure reduction control valve is the solenoid valve according to the invention.

### BRIEF DESCRIPTION OF THE DRAWINGS

Other features and objects of the present invention will become apparent from the following description when taken in connection with the accompanying drawings, in which:

FIG. 1 is a sectional side view of a solenoid valve embodying this invention;

FIG. 2 is a partially cutaway perspective view of the yoke shown in FIG. 1;

FIG. 3 is a partial sectional view of the solenoid valve of FIG. 1;

FIG. 4 is a graph showing the relationship between the time during which the coil is activated and the coil temperature and resistance; and

FIG. 5 is a schematic side view of a typical actuator for controlling hydraulic pressure.

### DETAILED DESCRIPTION OF THE PREFERRED EMBODIMENT

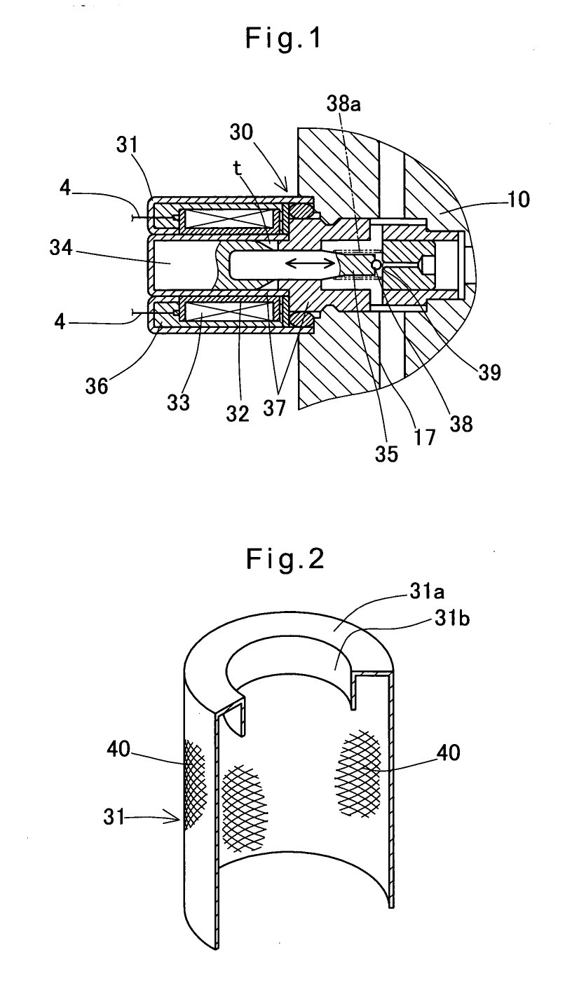

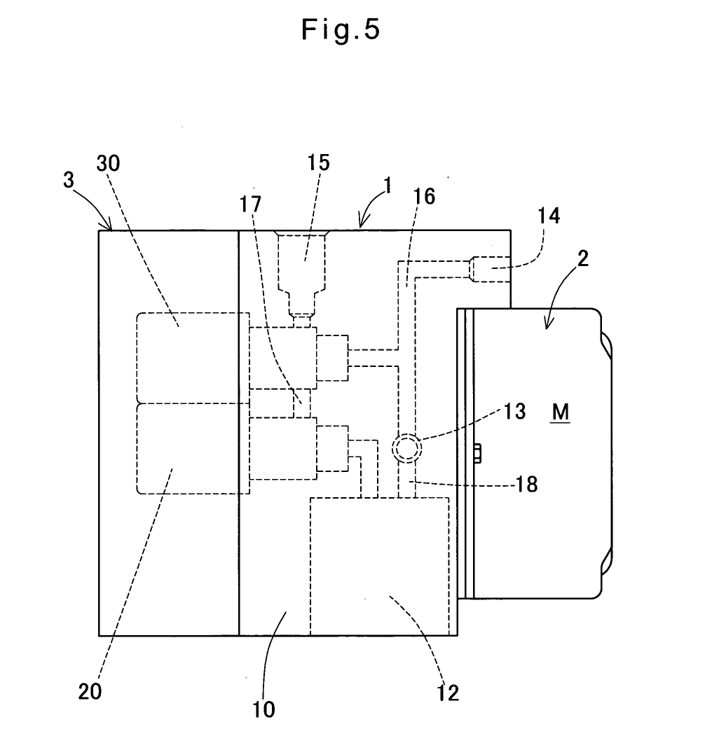

Now referring to the drawings, FIG. 1 shows the solenoid valve embodying the present invention, which is mounted in the hydraulic pressure control unit 1 shown in FIG. 5 as its pressure increase control valve 30. The control valve 30 of the embodiment is liquid-tightly sealed by a metal seal fitted in the housing 10 so as to extend across the passage 17 extending from the wheel cylinder port 15.

The control valve 30 of the embodiment includes a tubular metallic yoke 31 having an open front end, a tubular bobbin 32 inserted in the yoke 31 from its open front end so as to be coaxial with the yoke 31, and a current-excitable coil 33 wound around the bobbin 32. An epoxy resin 36 is charged into the space between the coil 33 and the yoke 31 by e.g. molding. A movable core (plunger) 34 is axially slidably supported in the bobbin 32 through a guide 37. With the core 34 seated on the rear end wall of the guide 37 as shown in FIG. 1, a gap t is present between the front end wall of the guide 37 and the front end of the core 34. Thus the core 34 can axially move a distance equal to the gap t. The core 34 carries a valve shaft 35 having a valve body 38 at its tip. By selectively activating the coil 33, the valve shaft 35 is axially moved together with the core 34 until the valve body 38 contacts or separates from a valve seat 39. The coil 33 is energized by electricity supplied through lead wires 4. The valve shaft 35 is biased away from the valve seat 39 by a spring 38a.

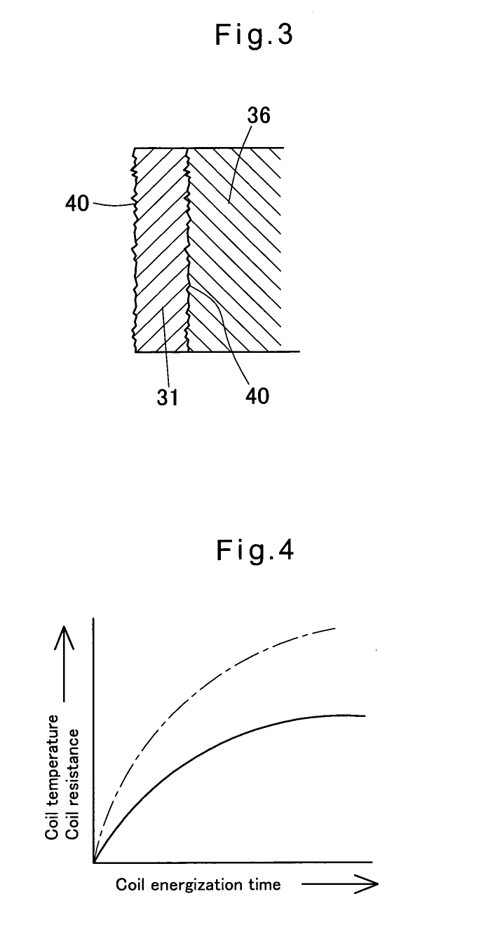

The yoke 31 has its radially inner and outer surfaces roughened by knurling as shown at 40 in FIG. 2. By roughening the radially inner surface of the yoke 31, the contact area between the yoke 31 and the resin 36 increases because the resin 36 infiltrates into every recess in the roughened surface 40 as shown in FIG. 3. This accomplishes smoother, quicker conduction of the heat produced from the coil 33 to the yoke 31 through the resin 36.

The heat conducted to the yoke 31 is partly conducted to the housing 10 of the hydraulic pressure control unit. Since the housing 10 is large in heat capacity, heat conducted to the housing 10 can be dissipated efficiently. By roughening the radially outer surface of the yoke 31, its surface area increases, so that heat can be more efficiently dissipated from the radially outer roughened surface 40. Overall, by roughening the radially inner and outer surfaces of the yoke 31, efficiency in the heat dissipation through the yoke 31 improves dramatically. This minimizes the possibility of overheating of the coil 33. The yoke has a flange 31a and a radially inner cylindrical wall 31b. The inner and outer surfaces of one or both of the flange 31a and the cylindrical wall 31b may also be roughened.

To confirm the advantage of the present invention, a solenoid valve including a yoke 31 having only its radially inner surface roughened (valve according to the invention) and a solenoid valve having no such roughened surface 40 (conventional valve) were mounted in separate control units as shown in FIG. 5 and the control units were operated to perform brake hydraulic pressure control. When the control units were operated until the coil 33 in the conventional valve had overheated (i.e. heated to over 200° C.) to near heat loss, the valve according to the invention was heated to only around 190° C., where there is practically no possibility of heat loss. The results of this experiment are shown in the form of a graph in FIG. 4. In the graph, the solid line indicates the relationship between the temperature and resistance of the coil of the valve according to the invention and the duration of energization to the coil. The chain line indicates such a relationship for the conventional valve.

The valve of the embodiment is a pressure increase valve used in an actuator for controlling vehicle brake hydraulic pressure. But the valve according to the invention may be used as a pressure reduction valve used in such an actuator (e.g. the valve 20 of FIG. 5), or may be used as a solenoid valve in any other device where overheating of the coil is not preferable or simply not permissible.

By roughening the surface of the yoke, the coil is less likely to overheat. It is thus possible to use a larger current to produce a greater electromagnetic force without increasing the size of the valve, or to reduce the size of the valve without reducing the electromagnetic force produced from the valve.

1. A solenoid valve comprising a tubular yoke, a tubular bobbin inserted in said yoke, a current-excitable coil wound around said bobbin, a resin filling a gap between said yoke and said coil, a core inserted in said bobbin so as to be movable in an axial direction of said bobbin, and a valve shaft having a valve body and joined to said core so as to be axially movable together with said core, thereby bringing said valve body into contact with and out of contact with a valve seat provided opposite said valve body, said yoke having a radially inner surface which is roughened.

2. A solenoid valve comprising a tubular yoke, a tubular bobbin inserted in said yoke, a current-excitable coil wound around said bobbin, a resin filling a gap between said yoke and said coil, a core inserted in said bobbin so as to be movable in an axial direction of said bobbin, and a valve shaft having a valve body and joined to said core so as to be axially movable together with said core, thereby bringing said valve body into contact with and out of contact with a valve seat provided opposite said valve body, said yoke having a radially outer surface which is roughened.

3. The solenoid valve according to claim 1 wherein said radially inner surface of said yoke is roughened by knurling.

4. The solenoid valve according to claim 2 wherein said radially outer surface of said yoke is roughened by knurling.

5. The solenoid valve according to claim 1 wherein said radially inner surface of said yoke is roughened by forming grooves in said radially inner surface.

6. The solenoid valve according to claim 2 wherein said radially outer surface of said yoke is roughened by forming grooves in said radially outer surface.

7. An actuator for controlling hydraulic pressure comprising a hydraulic pressure control unit including a pressure increase control valve, a pressure reduction control valve and a pump, a motor unit including a motor for driving said pump, and an electronic control unit for controlling said pressure increase control valve, said pressure reduction control valve and said motor,
wherein at least one of said pressure increase control valve and said pressure reduction control valve is the solenoid valve of claim 1.

8. An actuator for controlling hydraulic pressure comprising a hydraulic pressure control unit including a pressure increase control valve, a pressure reduction control valve and a pump, a motor unit including a motor for driving said pump, and an electronic control unit for controlling said pressure increase control valve, said pressure reduction control valve and said motor,
wherein at least one of said pressure increase control valve and said pressure reduction control valve is the solenoid valve of claim 2.
